(19) United States
(12) Patent Application Publication
(10) Pub. No.: US 2008/0172669 A1
(43) Pub. Date: Jul. 17, 2008

(54) System capable of executing workflows on target applications and method thereof

(75) Inventors: Gary Owen McCullough, Charlottesville, VA (US); Jun Ping Zhang, Scottsdale, AZ (US); David Scott Thompson, Tempe, AZ (US)

Correspondence Address: Walter P. Opaska;Bryan Cave LLP, Suite 2200, Two North Central Avenue, Phoenix, AZ, 85004, US

(73) Assignee: Carefx Corporation, Scottsdale, AZ (US)

(21) Appl. No.: 11/653,477

(22) Filed: Jan. 12, 2007

(51) Int. Cl. G06F 9/46

(52) U.S. Cl. 718/102

(57) ABSTRACT

A system (100) capable of executing one or more workflows on a target application include: a context manager application (101) having a communications module (120) capable of receiving information regarding a first workflow of the one or more workflows. The first workflow includes: (1) two or more groups of one or more first actions; and (2) one or more trigger events. The system also includes: (1) an execution engine module (112) capable of performing the two or more groups of the one or more first actions; and (2) a trigger monitor module (114) capable of detecting an occurrence of the one or more trigger events.

### FIELD OF THE INVENTION

This invention relates, in general, to a computer system for disseminating information and relates, in particular, to a computer system for executing a workflow in one or more target applications.

### BACKGROUND OF THE INVENTION

When using a computer, a user may change a variable or an item in a first computer application and may want this change to be transferred, duplicated, or copied by other active computer applications. In this manner, the other active computer applications are synchronized with the first computer application. For example, a person might login to a database or a network using a first application on a computer and might want other computer programs to login to the same database or network using the same login information entered into the first computer application. In another example, in the field of medicine, a nurse or a doctor can load data regarding one patient into one computer application and might want other computer applications also to load the same data regarding the same patient.

Computer applications can be synchronized with each other by executing a script on a second computer application to synchronize it with the first application. The computer script includes sleep or pause periods between commands in the script to provide the second computer application with time to respond to the first command before executing the second command. The sleep periods are necessary because the script could fail if the second computer application does not have enough time to respond to the first command before the script executes a second command. For example, a first command could open a window, and a second command could manipulate the appearance of the window. If a sleep period is not inserted between the commands, the script could try to manipulate the window before it is open. However, on a high performance computer, these sleep steps can dramatically slow down the execution of the script. On a low performance computer, these sleep steps might not be long enough to provide the second computer program adequate time to respond to the commands. Moreover, tweaking the sleep period in the script for each individual computer can be burdensome and time consuming if the script runs on multiple computers.

Thus, a need exists for a computer system to synchronize computer applications that executes efficiently on all computers.

### BRIEF DESCRIPTION OF THE DRAWINGS

Embodiments of the invention will be better understood from a reading of the following detailed description, taken in conjunction with the accompanying figures in the drawings in which:

FIG. 1 illustrates a block diagram of a system capable of executing workflows on a target application, according to a first embodiment;

FIG. 2 illustrates a flow chart for a method of executing the workflows on the target application using the system of FIG. 1, according to the first embodiment;

FIG. 3 illustrates a flow chart describing a process of providing a first workflow, according to the first embodiment;

FIG. 4 illustrates a flow chart describing a process of performing the first workflow, according to the first embodiment;

FIG. 5 illustrates an example of a workflow according to an embodiment;

FIG. 6 illustrates a main window of the target application before the execution of the workflow of FIG. 5, according to an embodiment;

FIG. 7 illustrates a find window of the target application, according to an embodiment;

FIG. 8 illustrates the main window of FIG. 5 after the patient ID has been changed, according to an embodiment;

FIG. 9 illustrates a computer that is suitable for implementing an embodiment of the system of FIG. 1; and

FIG. 10 illustrates a representative block diagram of the elements included on the circuit boards inside the chassis of the computer of FIG. 9.

For simplicity and clarity of illustration, the drawing figures illustrate the general manner of construction and the descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve the understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” “have,” and any variations thereof, are intended to cover a non-exclusive list, such that a process, method, article, or apparatus that comprises a list of elements is not necessarily limited to only those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in orientations other than those illustrated or described herein.

### DETAILED DESCRIPTION OF THE DRAWINGS

In an embodiment, a system capable of executing one or more workflows on a target application includes a context manager application having a communications module capable of receiving information regarding a first workflow of the one or more workflows, where the first workflow includes: (1) two or more groups of one or more first actions; and (2) one or more trigger events, where each of the one or more trigger events correspond to at least one group of the two or more groups of the one or more first actions. The system also includes: (1) an execution engine module capable of performing the two or more groups of the one or more first actions; and (2) a trigger monitor module capable of detecting an occurrence of the one or more trigger events. The execution engine module performs a first group of the two or more groups of the one or more first actions after the trigger monitor module detects the occurrence of a first trigger event of the one or more trigger events corresponding to a second group of the two or more groups of the one or more first actions. Furthermore, the execution engine module performs the second group of the two or more groups of the one or more first actions before the trigger module detects the occurrence of the first trigger event.

In a further embodiment, a method to execute a first workflow on a target application includes providing the first workflow to have: (1) a first action; (2) a first trigger event; and (3) a second action. The method also includes receiving a context to read or change from a user, a foreign application, or the target application. After the receiving the context, the method further includes performing the first workflow by, for example, (1) performing the first action on the target application or an operating system running the target application; (2) receiving a first indication that the first trigger event occurred; and (3) after receiving the first indication, performing the second action on the target application or the operating system. In the method, performing the first workflow drives the target application to a specific state where the context of the target application can be changed or the context of the target application can be read.

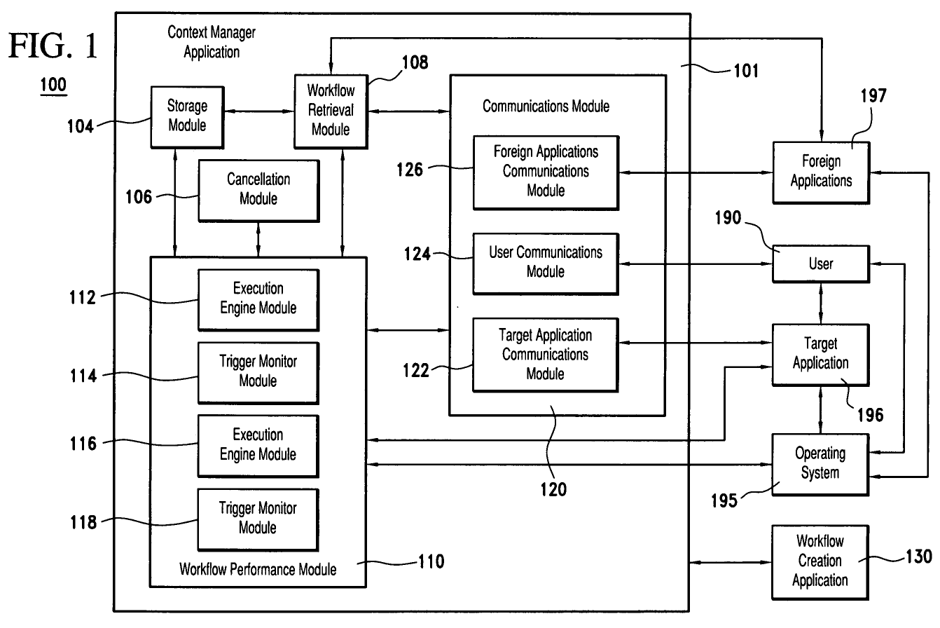

Turning to the figures, FIG. 1 illustrates a block diagram of a system 100 capable of executing one or more workflows on a target application 196 according to a first embodiment. In the same or a different embodiment, system 100 can execute one or more workflows on two or more target applications. For example, system 100 can execute a first workflow on a first target application and a second workflow on a second target application. System 100 can also be considered a system capable of disseminating information from one or more foreign applications 197 to target application 196. In one embodiment, system 100 can disseminate information from foreign applications 197 by communicating context changes in foreign applications 197 to target application 196. The dissemination of information can be accomplished, in part, by performing workflows to change the context in target application 196. In some embodiments, system 100 performs the workflows on target application 196 and disseminates information from foreign applications 197 without modifying the source or binary code for target application 196 and foreign applications 197. It should be understood that system 100 is merely exemplary and that the present invention may be employed in many embodiments not specifically depicted or otherwise described herein.

“Workflow,” as used herein, is a group of one or more actions and one or more trigger events used to accomplish a task on one or more target applications. In some embodiments, the workflow can be performed on one or more target application without having to modify the target applications. The workflow can include an indication as to the order of the actions and trigger events. In one example, a workflow can include a series of actions and trigger events to change a context. In another example, a workflow can include a series of actions and trigger events to read a context. In a further example, a workflow can include a series of actions and trigger events to open a window in the target application. In yet another example, a workflow can accomplish some other task in relation to one or more target applications.

In the same or a different embodiment, one or more of the groups of actions can also be a workflow. In one example, a first workflow has one or more second workflows embedded within. In some embodiments, the second workflows are not embedded in the first workflow but only references to the second workflows are included in the first workflow. In one example, system 100 can recognize the references to the second workflows and, when system 100 reaches each of the second workflows, system 100 can execute the second workflow before continuing the execution of the first workflow. In yet another embodiment, one or more third workflows can be embedded within the second workflows.

In one embodiment, a first workflow includes: (a) two or more groups of one or more first actions; and (b) one or more trigger events. Each of the trigger events corresponds to at least one group of the two or more groups of first actions. In some embodiments, performing the first workflow drives target application 196 to a specific state where the context of target application 196 can be changed or the context of target application 196 can be read.

In some embodiments, the first actions can include one or more result-accomplishing actions. In one example, the results-accomplishing actions can include a context changing action. The context changing action can change the context in target application 196. In the same or a different embodiment, actions in the one or more first actions, other than the results-accomplishing actions, can be considered preliminary or post-results actions. In one example, preliminary actions are performed before the results-accomplishing actions, and post-results actions are performed after the results-accomplishing actions.

In one example of the first workflow, a first group of the two or more groups of first actions includes a first action, and the one or more trigger events includes a first trigger event. The first trigger event corresponds to the first action. In this example, a second group of the two or more groups includes a second action. In some examples, the second action will be executed only after the first trigger event occurs. The one or more trigger events can also include a second trigger event corresponding to the second action, and a third group of the two or more groups of first actions can include a third action. In one embodiment, the first action is a preliminary action; the second action is a results-accomplishing action; and the third action is a post-results action.

In an embodiment, the one or more workflows can include a second workflow. The second workflow can include two or more second groups of one or more second actions and one or more second trigger events. Each of the trigger events corresponds to at least one group of the two or more second groups of second actions.

System 100 can include a context manager application 101 having: (a) a storage module 104 capable of storing one or more workflows; (b) a communications module 120 capable of receiving information regarding the workflows; (c) a workflow performance module 110 capable of detecting the trigger events and performing the actions; (d) a workflow retrieval module 108 capable of retrieving the workflows and passing the workflows to workflow performance module 110; and (e) a cancellation module 106 capable of stopping workflow performance module 110 if the occurrence of a trigger event is not detected.

In one embodiment, workflow performance module 110 includes: (a) an execution engine module 112 capable of performing the groups of first actions; and (b) a trigger monitor module 114 capable of detecting the occurrence of the trigger events. In some embodiments, workflow performance module 110 further includes an execution engine module 116 and a trigger monitor module 118. In one example, execution engine module 116 and trigger monitor module 118 are identical to or similar to execution engine module 112 and trigger monitor module 114, respectively.

In one example, execution engine module 112 can execute the first and second workflows, and trigger monitor module 114 can detect the trigger events in the first and second workflows. In another embodiment, execution engine module 112 and trigger monitor module 114 can perform the first workflow, and execution engine module 116 and trigger monitor module 118 can perform the second workflow.

In yet another embodiment, execution engine modules 112 and 116 can each perform a portion of the actions in a first workflow, and trigger monitor modules 114 and 118 can each detect a portion of the trigger events in the first workflow. For example, execution engine 112 can perform a first portion of the actions on a target application 196 and execution engine 116 can perform a second portion of the actions on a second target application. Likewise, trigger monitor module 114 can detect a portion of the trigger events on target application 196 and trigger monitor module 116 can detect a portion of the trigger events on the second target application. In some embodiments, multiple execution engines 112 and 116 and trigger monitor modules 114 and 118 can be useful when system 100 is employed in enterprise software.

In one embodiment, a first thread or process of an operating system 195 executes execution engine module 112 and trigger monitor module 114, and one or more second threads or processes of operating system 195 executes other portions of application 101. One or more different threads or processes of operating system 195 can run target application 196 in this embodiment. In one example, the first thread or process of operating system 195 also executes execution engine module 116 and trigger monitor module 118. In another example, a different thread or process of operating system 195 executes execution engine module 116 and trigger monitor module 118.

Using separate threads or processes for execution engine module 112 and trigger monitor module 114 prevents the performance of a workflow from blocking execution of either target application 196 or the other portions of application 101. Moreover, using separate threads allows execution of multiple workflows simultaneously. For example, the first instance of execution engine module 112 and trigger monitor module 114 can perform a first workflow on a first thread, and a second instance of execution engine module 112 and trigger monitor module 114 can perform a second workflow on a different thread. A third thread can execute other portions of application 101 in this example.

In one embodiment, communications module 120 includes: (a) a target application communications module 122 capable of receiving, from target application 196, information regarding the workflows; (b) a user communications module 124 capable of receiving, from a user 190, information regarding the workflows; (c) a foreign applications communications module 126 capable of receiving, from foreign applications 197, information regarding the workflows. In one example, the information regarding the workflows received by communications module 120 can be notification that a context has changed in target application 196. In a further example, the information received by foreign applications communications module 126 and/or user communications module 124 can be the context. In another example, the information received by target application communications module 122, user communications module 124, and/or foreign applications communications module 126 can be information other than information regarding a context. For example, communications module 120 can receive information regarding the opening of a window in target application 196.

In some embodiments, system 100 further includes a workflow creation application 130 capable of allowing a person to create the workflows. In non-illustrated embodiments, workflow creation application 130 can be part of application 101.

“System” and “application,” as used herein, can each refer to, or otherwise include, one computer application or two or more computer applications. “Target application,” as used herein, can refer to, or otherwise include, a single computer application or two or more computer applications, other than application 101 or operating system 195. “Foreign applications,” as used herein, can refer to, or otherwise include, one or more computer applications, other than application 101 or operating system 195. Foreign applications 197 and target application 196 can communicate with application 101 directly or indirectly through other applications, a network, and/or operating system 195. In some embodiments, one application can function as both a target application and a foreign application. For example, system 100 can execute workflows on a first application while disseminating information from the first application to one or more second applications.

Operating system 195 is, in one embodiment, a software program that manages the hardware and software resources of a computer and/or a computer network. Operating system 195 performs basic tasks such as, for example, controlling and allocating memory, prioritizing the processing of instructions, controlling input and output devices, facilitating networking, and managing files. Examples of common operating systems include Microsoft® Windows, Mac® OS, UNIX® OS, and Linux®OS. Application 101, foreign applications 197, target application 196, and operating system 195 can be located on the same computer and/or on different computers on the same computer network.

“Context,” as used herein, refers to or otherwise includes an identifying variable or variables in the target application that can be changed, manipulated, defined, or set by a user or foreign applications. For example in the health care field, when viewing patient information, the context can be the patient identifier (“patient ID”) in the database or on the network. When logging into a network, the context can be the user ID. In another example, when entering billing information into an accounting application, the context can be the transaction number and/or the customer number.

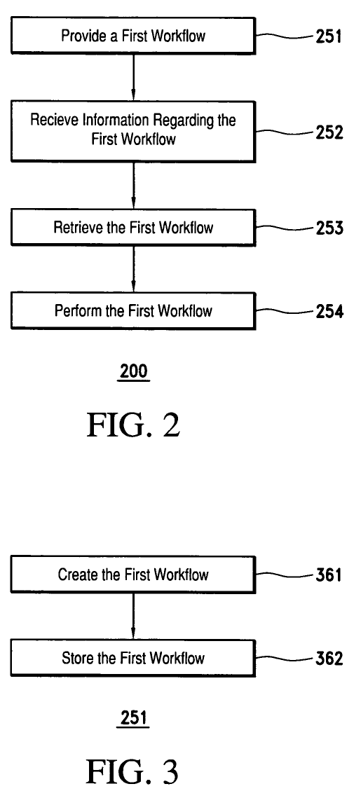

FIG. 2 illustrates a flow chart for a method 200 of executing workflows on target application 196 (FIG. 1) using system 100 (FIG. 1), according to the first embodiment. Method 200 is merely illustrative of a technique for implementing the various aspects of one embodiment described herein, and system 100 (FIG. 1) and method 200 are not limited to this particular embodiment, as numerous other embodiments are possible. For example, the embodiment discussed below will focus on performance of a single workflow. However, system 100 (FIG. 1) and method 200 are not limited to performing a single workflow and can also perform two or more workflows sequentially or simultaneously. In some embodiments, the techniques illustrated in FIG. 2 can be implemented using the Microsoft® Windows platform or by using the Java® platform.

In one embodiment, the first step in method 200 is a step 251 providing a first workflow. FIG. 3 illustrates a flow chart describing step 251, according to the first embodiment.

Referring to FIG. 3, the first process of step 251 is a process 361 of creating the first workflow. In the embodiment illustrated in FIG. 1, a person can create a first workflow by entering the elements of the first workflow into workflow creation application 130, and workflow creation application 130 can generate the first workflow. In another example, a person can record data needed to create the first workflow, and workflow creation application 130 can use the data to create the first workflow. An example of workflow creation application 130 and a method used to record a workflow is illustrated in co-owned and co-pending U.S. patent application Ser. No. 11/493,300 to Weng et al., entitled “COMPUTER PROGRAM GENERATION SYSTEM AND METHOD THEREOF,” which is incorporated herein by reference. In an alternative embodiment, process 361 (FIG. 3) is skipped because the first workflow has already been created.

Referencing again FIG. 3, the next process in step 251 is a process 362 of storing the first workflow. In the embodiment illustrated in FIG. 1, the first workflow can be stored in storage module 104. In one example, after creating the first workflow, workflow creation application 130 communicates the first workflow to application 101, which stores the first workflow in storage module 104. In another example, the first workflow is communicated to application 101 from a person, target application 196, or foreign applications 197.

Referring again to FIG. 2, the next step in method 200 is a step 252 of receiving information regarding the first workflow. In some embodiments, receiving this information can act as an indication to begin the execution of the first workflow. In the embodiment illustrated in FIG. 1, communications module 120 can receive the information. For example, foreign applications communications module 126 can receive the information regarding the first workflow from foreign applications 197. In another example, user communications module 124 can receive the information regarding the first workflow from user 190 or another person. In a further example, target application communications module 122 can receive the information regarding the first workflow from target application 196.

In one embodiment, the information received from user 190, foreign applications 197, or target application 196 contains a context to change or read in target application 196. In one example, the information also includes instructions to perform the first workflow. In another example, the information includes a context and a value for the context. In still another example, the information includes a context and instructions to read the value of the context in target application 196. In another embodiment, the information includes instructions to open a specific window or perform another task in target application 196. In some embodiments, the information includes the first workflow to perform.

Referring back to FIG. 2, the next step in method 200 is a step 253 of retrieving the first workflow. In the embodiment illustrated in FIG. 1, communications module 120 can communicate the information regarding the first workflow to workflow retrieval module 108. Workflow retrieval module 108 can acquire the first workflow from storage module 104. In other embodiments, communications module 120 communicates the first workflow to workflow retrieval module 108.

In some embodiments, after communications module 120 receives the information regarding the first workflow, application 101 can instruct workflow retrieval module 108 to retrieve the first workflow and can command workflow performance module 110 to perform the first workflow. In one embodiment, workflow performance module 110 does not perform the first workflow until after it receives the first workflow from workflow retrieval module 108.

In alternative embodiments, application 101 does not include workflow retrieval module 108 and storage module 104, or communications module 120 communicates the first workflow to workflow performance module 110.

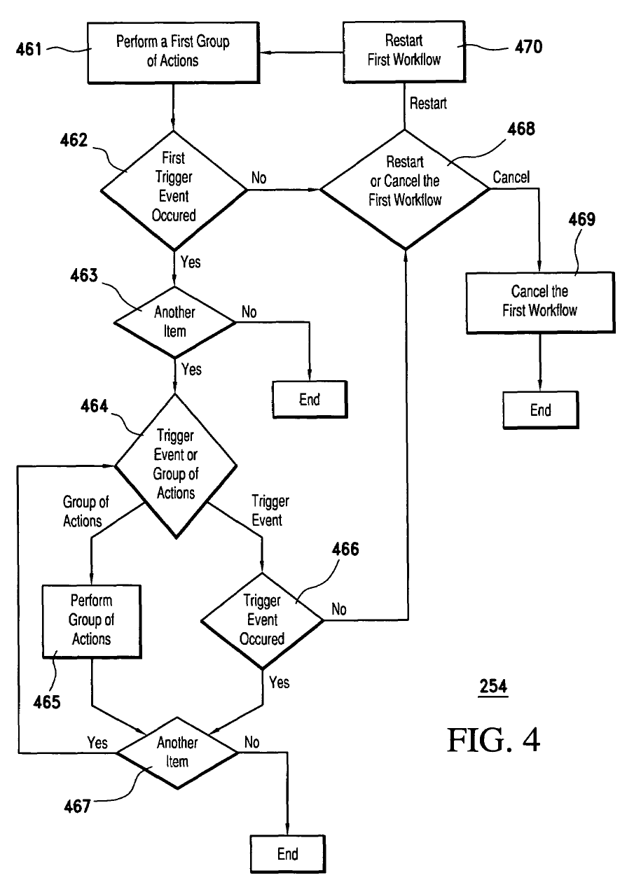

Again, referencing FIG. 2, the next step in method 200 is a step 254 of performing the first workflow. As discussed above, the first workflow includes a series of actions and trigger events. The first workflow is performed by performing each of the groups of one or more actions in the first workflow. FIG. 4 illustrates a flow chart describing step 254, according to the first embodiment.

The first process in step 254 is a process 461 of performing a first group of actions. In the embodiment illustrated in FIG. 1, execution engine module 112 performs the first group of actions on target application 196 and/or operating system 195. Execution engine module 112 performs the first group of actions by executing each individual action in the first group of actions on target application 196 and/or operating system 195. In one embodiment, the group of actions are performed sequentially. In a different embodiment, the first group of actions consists of a single action. Information obtained during the performance of the first group of actions can be stored for future use. For example, control information about a window in target application 196 can be stored in storage module 104.

Referring back to FIG. 4, the next process in step 254 is a process 462 of testing whether a first trigger event occurred. In the first workflow, the first group of actions is followed by a first trigger event. In the embodiment illustrated in FIG. 1, trigger monitor module 114 detects the occurrence of the first trigger event. That is, trigger monitor module 114 receives an indication that the first trigger event occurred. In one embodiment, trigger monitor module 114 receives the indication from target application 196 or operating system 195. For example, if the trigger event is the creation of a window, trigger monitor module 114 can query operating system 195 or target application 196 to get the control information of the newly created window. In the example where the operating system is Microsoft Windows, the control information can be the handle for the window. The existence of the control information for the window is considered an indication that the creation of the window (i.e., the trigger event) occurred.

In some embodiments, information received during the testing of whether the trigger event occurred can be stored for future use. In one embodiment, the information is stored in storage module 104. For example, the control information for a window could be stored in storage module 104.

In one embodiment, trigger monitor module 114 waits a period of time before ascertaining if the trigger event occurred. The wait time allows time for target application 196 to respond to the last action. In one embodiment, user 190 or another person can program the wait time. In another embodiment, the amount of wait time can be included in the first workflow. In some embodiments, after the wait period has ended, trigger monitor module 114 can wait another period of time to receive an indication that the first trigger event occurred before concluding that the first trigger event did not occur.

Once again referring to FIG. 4, if the trigger event does not occur, the next process in step 254 is a process 468 of deciding whether to restart or cancel the first workflow. In the embodiment illustrated in FIG. 1, trigger monitor module 114 can communicate to cancellation module 106 that the trigger event failed to occur. If a trigger event does not occur, cancellation module 106 can either restart the first workflow or cancel the performance of the first workflow. In one embodiment, cancellation module 106 is programmed to either cancel or restart the first workflow if a trigger event does not occur. In one example, user 190 or another person programs the response into application 101. In a further embodiment, the first workflow includes instructions on how to proceed if a trigger event does not occur. The first workflow can include individual instructions for each trigger event or one universal set of instructions. In another embodiment, cancellation module 106 can ask user 190 whether to cancel or restart the first workflow. In one example, cancellation module communicates to user 190 through user communications module 124. In yet another embodiment, workflow performance module 110 decides whether to restart or cancel the first workflow.

Referring back to FIG. 4, if the performance of the first workflow is cancelled, the next process in step 254 is a process 469 of canceling the first workflow. When cancellation of the first workflow occurs, processes or threads associated with the performance of the first workflow can be terminated. In one embodiment, user communications module 124 (FIG. 1) informs user 190 (FIG. 1) that the first workflow terminated because a trigger event failed to occur.

If the first workflow is restarted, instead of canceling the performance in process 469, the next process in step 254 is a process 470 of restarting the first workflow. In the embodiment illustrated in FIG. 1, cancellation module 106 can terminate any process, thread, or application begun or used by the first workflow and can begin any processes, thread, or application needed by the first workflow. In the same or a different embodiment, cancellation module 106 can restore target application 196 and/or operating system 195 to their state immediately before the immediately previous performance of the first workflow commenced. In some embodiments, cancellation module 106 can also clear any information stored in storage module 104 regarding the immediately previous performance of the first workflow.

In a non-illustrated embodiment, instead of restarting or canceling the first workflow, cancellation module 106 can instruct execution engine module 112 to re-execute one or more of the actions in the last group of actions performed.

Now referring yet again to FIG. 4 and assuming process 462 received an indication that the trigger event occurred, the next process in step 254 is a process 463 of testing whether the first workflow includes any additional items. If not, in one embodiment, step 254 and method 200 are complete. In the example illustrated in FIG. 1, workflow performance module 110 can test the first workflow to see if the first workflow includes any additional trigger events or groups of actions.

Referring back to FIG. 4, if the first workflow includes additional trigger events or groups of actions, then the next process in step 254 is a process 464 of testing whether the next item in the first workflow is a group of actions or a trigger event. In the embodiment illustrated in FIG. 1, workflow performance module 110 tests whether the next item is a group of actions or a trigger event. If the next item is a group of actions, then the next process in step 254 is a process 465 (FIG. 4). If the next item is a trigger event, the next process in step 254 is a process 466 (FIG. 4). In some embodiments, processes 465 or 466 are performed only if the trigger event corresponding to the last group of actions occurred.

Referring again to FIG. 4, in the case where the next item is a group of actions, the next process in step 254 is process 465 of executing the group of actions. In one embodiment, executing the group of actions in process 465 is similar to the execution of the first group of actions in process 461.

For the case where the next item is a trigger event, the next process in step 254 is process 466 of testing whether the trigger event occurred. In one embodiment, the testing in process 466 is similar to testing whether the first trigger event occurred in process 462. Similar to process 462, if the trigger event does not occur in process 466, process 468, is performed to decide whether to restart or cancel the first workflow.

After performing the group of actions in process 465 or detecting whether the trigger event occurred in process 466, the next process in step 254 is process 467 of testing whether the first workflow includes another item. Process 467 can be similar to process 463. If the first workflow includes another group of actions or a trigger event, then the next process in step 254 is process 464. In one embodiment, if the first workflow does not include any additional items, step 254 and method 200 (FIG. 2) are complete.

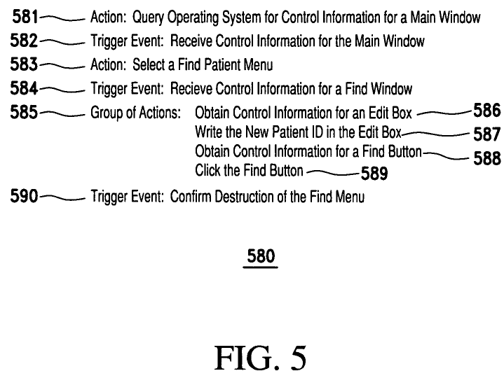

The execution of an exemplary first workflow will now be explained to illustrate the embodiments described in relation to FIGS. 1-4. The first workflow in this example can change the active patient ID, i.e., the context in an exemplary target application 196 (FIG. 1). In this example, a first workflow to change the active patient ID has already been retrieved and instructions to change the patient ID to “WRN-5: Smith, Jane” have been received. FIG. 5 illustrates a workflow 580 according to an embodiment. Workflow 580 is capable of changing the patient ID in target application 196 (FIG. 1). Workflow 580 is shown in FIG. 5 as a series of phrases describing each group of actions or trigger event. However, in one embodiment, when the workflow is stored in storage module 104 (FIG. 1), and executed by workflow performance module 110 (FIG. 1), the workflow can exist in a machine readable form. For example, the workflow can be a list of functions or procedure calls. In another embodiment, the workflow is stored as binary or object code.

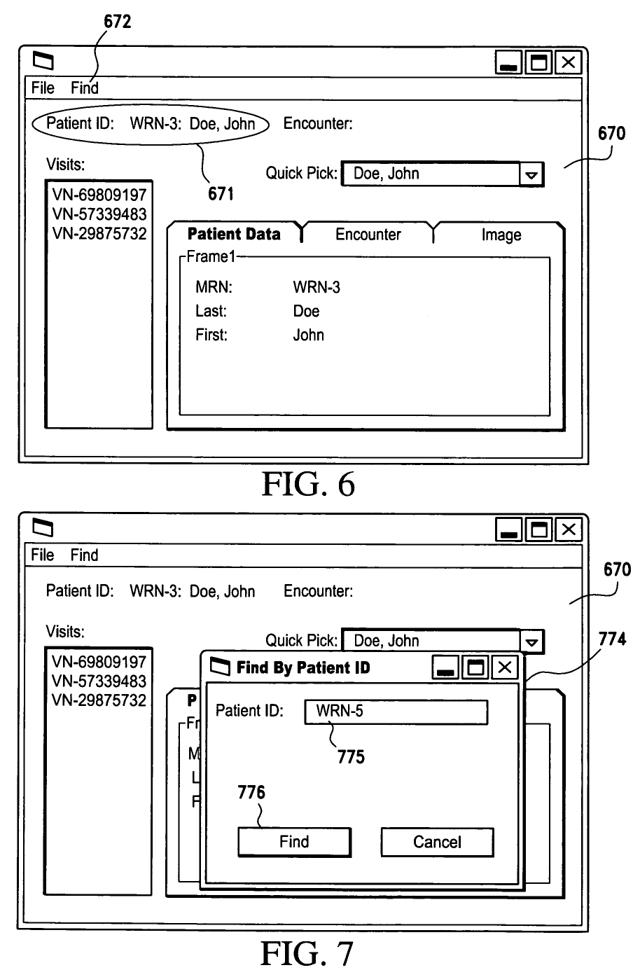

FIG. 6 illustrates a main window 670 of target application 196 (FIG. 1) before the execution of workflow 580 according to an embodiment. A patient ID 671 in target application 196 (FIG. 1) as shown in window 670 is “WRN-3: Doe, John.”

Referring back to FIG. 5, the first item in workflow 580 is an action 581 of querying operating system 195 (FIG. 1) for the control information about window 670 (FIG. 6). Performing action 581 corresponds to process 461 in FIG. 4. In other operating systems, the operating system is queried for the control information needed to execute actions on target application 196 (FIG. 1). In the embodiment illustrated in FIG. 1, execution engine module 112 queries operating system 195 for the control information.

Referring again to FIG. 5, the next item in workflow 580 is a trigger event 582 of receiving the control information about window 670 (FIG. 6). Receiving trigger event 582 corresponds to process 462 in FIG. 4. In this case, the indication of the trigger event is the reception of the control information. In the embodiment illustrated in FIG. 1, trigger monitor module 114 receives the control information from operating system 195. In one example, trigger monitor module 114 communicates the control information to storage module 104 for storage. When operating system 195 (FIG. 1) is Microsoft Windows, operating system 195 (FIG. 1) can return the handle for window 670 (FIG. 6). In other operating systems, other control information can be returned.

If the control information is not returned by operating system 195 or a null value is returned, cancellation module 106 can restart or cancel performance of workflow 580.

Referring again to FIG. 5, the next item in workflow 580 is an action 583 of selecting a find menu 672 (FIG. 6). Performing action 583 corresponds to process 465 in FIG. 4. When user 190 (FIG. 1) selects find menu 672 (FIG. 6), target application 196 (FIG. 1) creates a find window that allows selection of a patient by patient ID. In the embodiment illustrated in FIG. 1, execution engine module 112 selects find menu 672 (FIG. 6). In one example, execution engine module 112 sends a command to target application 196 instructing it to select find menu 672 (FIG. 6). In another example, execution engine module 112 mimics the action of a person clicking on find menu 672 (FIG. 6) with a mouse. Execution engine module 112 can mimic the actions of the person by sending the same command(s) to operating system 195 and/or target application 196 that would be sent if a person had actually clicked on find menu 672 (FIG. 6).

Referring yet again to FIG. 5, the next item in workflow 580 is a trigger event 584 of receiving the control information about the find window of target application 196 (FIG. 1). Receiving an indication that trigger event 584 occurred corresponds to process 466 in FIG. 4. In this case, the indication of the trigger event is the reception of the control information for the find window. FIG. 7 illustrates a find window 774 of target application 196 (FIG. 1) according to an embodiment.

In the embodiment illustrated in FIG. 1, trigger monitor module 114 can receive the control information from operating system 195. In one example, trigger monitor module 114 communicates the control information to storage module 104 for storage. When operating system 195 is Microsoft Windows, operating system 195 returns the handle for find window 774 (FIG. 7) and possibly other control information (e.g., handle information for an edit box 775 (FIG. 7) and/or handle information for a find button 776 (FIG. 7)). In other operating systems, the control information necessary to perform actions can be returned.

Referring back to FIG. 5, the next item in workflow 580 is a group of actions 585. Group of actions 585 includes four individual actions: (a) an action 586 of obtain control information for edit box 775 (FIG. 7); (b) an action 587 of writing the new patient ID in edit box 775 (FIG. 7); (c) an action 588 of obtain control information for find button 776 (FIG. 7); and (d) an action 589 of clicking find button 776 (FIG. 7). Performing group of actions 585 corresponds to other performance of process 465 in FIG. 4. In one embodiment, actions 586, 587, 588, and 589 are considered result-accomplishing actions because group of actions 585 include a context changing action. In one embodiment, action 589 of clicking find button 776 (FIG. 7) manipulated the context of target application 196 (FIG. 1) and is, thus, a context-changing action.

In the embodiment illustrated in FIG. 1, execution engine module 112 performs group of actions 585 (FIG. 5) by sequentially performing each action 586, 587, 588, and 589 (FIG. 5). In one example, control information for edit box 775 (FIG. 7) and find button 776 (FIG. 7) are obtained by querying operating system 195. In another embodiment, the control information for edit box 775 (FIG. 7) and find button 776 (FIG. 7) are stored in storage module 104, and execution engine module 112 retrieves the control information from storage module 104. A trigger event is not necessary to confirm the receiving of the existence of edit box 775 (FIG. 7) and find button 776 (FIG. 7) because the existence of find window 774 (FIG. 7) has already been confirmed. However, in some examples, workflow 580 (FIG. 5) includes trigger events following each of the actions 586 and 588 (FIG. 5) to confirm receipt of the control information.

In one embodiment, execution engine module 112 performs action 587 (FIG. 5) by retrieving the new patient ID from storage module 104. Execution engine module 112 then writes the new patient ID, “WRN-5,” into edit box 775 (FIG. 7) by sending a command to target application 196 to enter the information. In another example, execution engine module 112 mimics the action of a person typing the new patient ID into edit box 775 (FIG. 7).

Similarly, in one example, executive engine module 112 performs action 589 (FIG. 5) by sending a command to target application 196 to click find button 776 (FIG. 7). In a further example, execution engine module 112 clicks find button 776 (FIG. 7) by mimicking the actions of a person clicking find button 776 (FIG. 7).

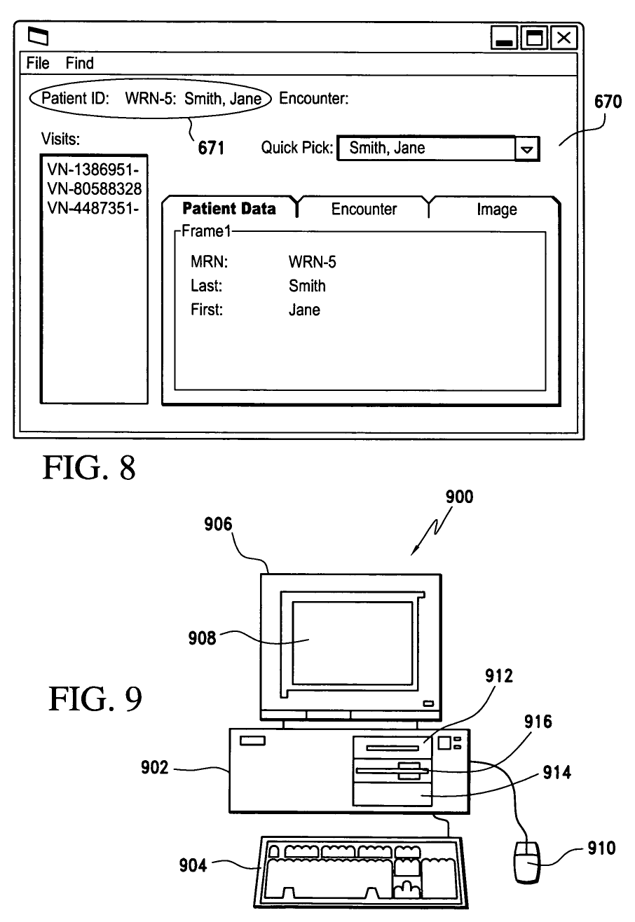

Referring back to FIG. 5, the next item in workflow 580 is a trigger event 590 of confirming the destruction of find window 774 (FIG. 7). After find button 776 (FIG. 7) is clicked, operating system 195 and/or target application 196 should destroy find window 774 (FIG. 7). Additionally, the patient ID should be changed in window 670 (FIG. 6). FIG. 8 illustrates window 670 after the patient ID has been changed, according to an embodiment. In window 670, patient ID 671 has been changed to “WRN-5: Smith, Jane.”

In the embodiment illustrated in FIG. 1, trigger monitor module 114 tests to see if find window 774 (FIG. 7) was destroyed by querying operating system 195 to obtain the control information for find window 774 (FIG. 7). The return of a null value or a window does not exist error is considered an indication by trigger monitor module 114 that find window 774 (FIG. 7) was destroyed. Receiving an indication that trigger event 590 occurred corresponds to another occurrence of process 466.

In some embodiments, trigger event 590 (FIG. 5) can be omitted. In these embodiment, workflow 580 (FIG. 5) ends with the performance of action 589 (FIG. 5).

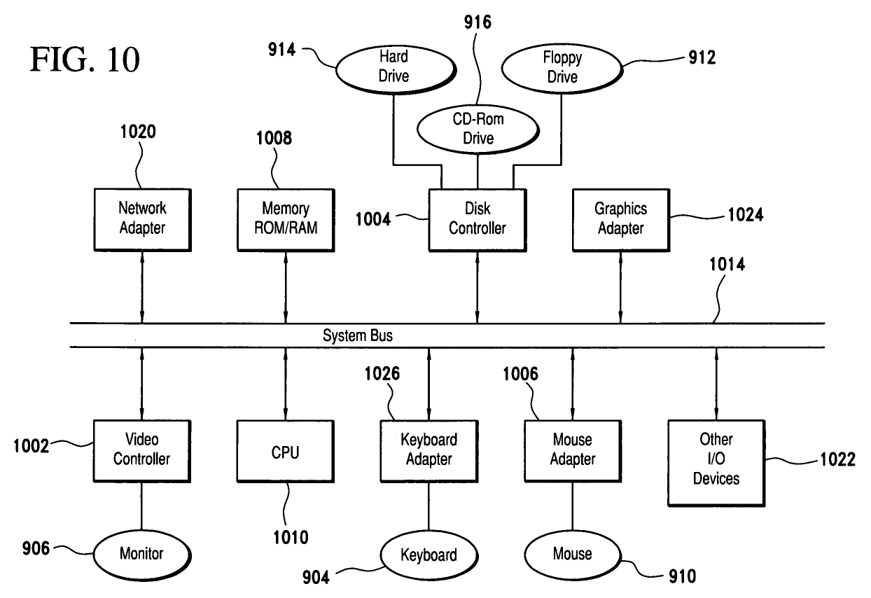

FIG. 9 illustrates a computer 900 that is suitable for implementing an embodiment of system 100 (FIG. 1). Computer 900 includes a chassis 902 containing one or more circuit boards (not shown), a floppy drive 912, a Compact Disc Read-Only Memory (CD-ROM) drive 916, and a hard drive 914. A representative block diagram of the elements included on the circuit boards inside chassis 902 is shown in FIG. 10. A central processing unit (CPU) 1010 in FIG. 10 is coupled to a system bus 1014 in FIG. 10. In various embodiments, the architecture of CPU 1010 can be compliant with any of a variety of commercially distributed architecture families including the RS/6000 family, the Motorola 68000 family, or the Intel x86 family.

System bus 1014 also is coupled to memory 1008 that includes both read only memory (ROM) and random access memory (RAM). Non-volatile portions of memory 1008 or the ROM can be encoded with a boot code sequence suitable for restoring computer 900 (FIG. 9) to a functional state after a system reset. In addition, memory 1008 can include microcode such as a Basic Input-Output System (BIOS).

In the depicted embodiment of FIG. 10, various I/O devices such as a disk controller 1004, a graphics adapter 1024, a video controller 1002, a keyboard adapter 1026, a mouse adapter 1006, a network adapter 1020, and other I/O devices 1022 can be coupled to system bus 1014. Keyboard adapter 1026 and mouse adapter 1006 are coupled to a keyboard 904 (FIGS. 9 and 10) and a mouse 910 (FIGS. 9 and 10), respectively, of computer 900 (FIG. 9). While graphics adapter 1024 and video controller 1002 are indicated as distinct units in FIG. 10, video controller 1002 can be integrated into graphics adapter 1024, or vice versa in other embodiments. Video controller 1002 is suitable for refreshing a monitor 906 (FIGS. 9 and 10) to display images on a screen 908 (FIG. 9) of computer 900 (FIG. 9). Disk controller 1004 can control hard drive 914 (FIGS. 9 and 10), floppy drive 912 (FIGS. 9 and 10), and CD-ROM drive 916 (FIGS. 9 and 10). In other embodiments, distinct units can be used to control each of these devices separately.

Although many other components of computer 900 (FIG. 9) are not shown, such components and their interconnection are well known to those of ordinary skill in the art. Accordingly, further details concerning the construction and composition of computer 900 and the circuit boards inside chassis 902 (FIG. 9) need not be discussed herein.

When computer 900 in FIG. 9 is running, program instructions stored on a floppy disk in floppy drive 912, on a CD-ROM in CD-ROM drive 916, on hard drive 914, or in memory 1008 (FIG. 10) are executed by CPU 1010 (FIG. 10). A portion of the program instructions, stored on these devices, can be suitable for carrying out the method of monitoring a target application with system 100 (FIG. 1) as described previously with respect to FIGS. 1-8.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that steps 251-254 of FIG. 2, processes 461-470 of FIG. 4, or any element of FIG. 1 may be comprised of many different steps and be performed by many different modules, and that the foregoing discussion of certain of these embodiments does not necessarily represent a complete description of all possible embodiments. For example, system 100 (FIG. 1) and method 200 (FIG. 2) described herein are not limited to reading or changing contexts. Instead, system 100 (FIG. 1) and method 200 (FIG. 2) can be used to also drive target application 196 (FIG. 1) to any number of states. In other examples, computer 900 in FIG. 9 can be replaced with a computer network.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system capable of executing one or more workflows on a target application comprising:
a context manager application comprising:
a communications module capable of receiving information regarding a first workflow of the one or more workflows, the first workflow comprising:
two or more groups of one or more first actions; and
one or more trigger events, each of the one or more trigger events corresponding to at least one group of the two or more groups of the one or more first actions;
an execution engine module capable of performing the two or more groups of the one or more first actions; and
a trigger monitor module capable of detecting an occurrence of the one or more trigger events,
wherein:
the execution engine module performs a first group of the two or more groups of the one or more first actions after the trigger monitor module detects the occurrence of a first trigger event of the one or more trigger events corresponding to a second group of the two or more groups of the one or more first actions; and
the execution engine module performs the second group of the two or more groups of the one or more first actions before the trigger module detects the occurrence of the first trigger event.

2. The system of claim 1, wherein:
at least one action in the two or more groups of the one or more first actions manipulates or reads a context of the target application.

3. The system of claim 1, wherein:
the execution engine module performs a third group of the two or more groups of the one or more first actions before performing the second group.

4. The system of claim 1, wherein:
the execution engine module performs a third group of the two or more groups of the one or more first actions after performing the first group.

5. The system of claim 1, wherein:
the execution engine module performs the first group of the two or more groups of the one or more first actions only after the trigger monitor module detects the occurrence of the first trigger event of the one or more trigger events.

6. The system of claim 1, wherein:
the execution engine module performs the two or more groups of the one or more first actions on the target application or an operating system running the target application.

7. The system of claim 1, wherein:
the trigger monitor module detects the occurrence of the one or more trigger events in the target application.

8. The system of claim 1, wherein:
the communications module comprises:
a target application communications module capable of receiving, from the target application, information regarding the first workflow.

9. The system of claim 1, wherein:
the communications module comprises:
a user communications module capable of receiving, from a user, information regarding a context; and
the information regarding the first workflow is the context.

10. The system of claim 1, wherein:
the communications module comprises:
a foreign applications communications module capable of receiving, from one or more foreign applications, information regarding a context; and
the information regarding the first workflow is the context.

11. The system of claim 1, wherein:
the context manager application instructs the execution engine module to perform the two or more groups of the one or more first actions after the communications module receives the information regarding the first workflow.

12. The system of claim 1, wherein:
the context manager application is separate from the target application.

13. The system of claim 1, wherein:
the execution engine module and the trigger monitor module are executed on one or more first threads of an operating system running the context manager application; and
other portions of the context manager application are executed on one or more second threads of the operating system.

14. The system of claim 1, wherein:
the context manager application further comprises:
a storage module capable of storing the first workflow.

15. The system of claim 14, wherein:
the context manager application further comprises:
a workflow retrieval module capable of retrieving the first workflow of the one or more workflows from the storage module.

16. The system of claim 14, wherein:
the storage module is further capable of storing data related to the first workflow of the one or more workflows; and
the first execution engine module is further capable of using the data when performing the two or more groups of the one or more first actions.

17. The system of claim 1, wherein:
the communications module is further capable of receiving information regarding a second workflow of the one or more workflows, the second workflow comprising:
two or more second groups of one or more second actions; and
one or more second trigger events, each of the one or more second trigger events corresponding to at least one group of the two or more groups of the one or more second actions.

18. The system of claim 17, wherein:
the execution engine module is further capable of performing the two or more second groups of the one or more second actions.

19. The system of claim 18, wherein:
the trigger monitor module is further capable of detecting an occurrence of the one or more second trigger events.

20. The system of claim 17, wherein:
the context manager application further comprises:
a second execution engine capable of performing the two or more second groups of the one or more second actions.

21. The system of claim 20, wherein:
the context manager application further comprises:
a second trigger monitor module capable of detecting an occurrence of the one or more second trigger events.

22. The system of claim 1, wherein:
the context manager application further comprises:
a cancellation module capable of stopping the execution engine module if the trigger monitor module does not detect the occurrence of the first trigger event.

23. The system of claim 1, further comprising:
a workflow creation application capable of allowing a user to create the first workflow of the one or more workflows.

24. A system for performing one or more workflows on a target application comprising:
a storage module capable of storing a first workflow of the one or more workflows, the first workflow comprising:
one or more first preliminary actions;
a first trigger event; and
one or more result-accomplishing actions;
a foreign applications communications module capable of receiving, from one or more foreign applications, information regarding the first workflow; and
a workflow performance module capable of detecting the first trigger event and performing the one or more result-accomplishing actions and the one or more first preliminary actions, wherein:
the workflow performance module performs the one or more first preliminary actions and, after receiving an indication that the first trigger event occurred, performs the one or more result-accomplishing actions.

25. The system of claim 24, wherein:
the one or more result-accomplishing actions include a context changing action; and
the context changing action of the one or more result-accomplishing actions changes the context in the target application.

26. The system of claim 24, further comprising:
a target application communications module capable of receiving, from the target application, information regarding the first workflow.

27. The system of claim 24, further comprising:
a user communications module capable of receiving, from a user, information regarding the first workflow.

28. The system of claim 24, wherein:
the first workflow further comprises:
one or more second preliminary actions; and
a second trigger event;
the workflow performance module performs the one or more first preliminary actions after detecting the occurrence of the second trigger event; and
the workflow performance module performs the one or more second preliminary actions before detecting the occurrence of the second trigger event.

29. The system of claim 24, wherein:
the first workflow further comprises:
one or more post-results actions; and
a second trigger event;
the workflow performance module performs the one or more post-results actions after detecting the occurrence of the second trigger event; and
the workflow performance module performs the one or more result-accomplishing actions before detecting the occurrence of the second trigger event.

30. The system of claim 24, wherein:
the workflow performance module operates on a first thread of an operating system running the target application; and
the workflow retrieval module and the receiving module operate on one or more second threads of the operating system.

31. The system of claim 30, wherein:
the target application operates on at least a third thread of the operating system.

32. The system of claim 24, further comprising:
a workflow retrieval module capable of acquiring the first workflow from the storage module.

33. A method of executing a first workflow on a target application comprising:
providing the first workflow to comprise:
a first action;
a first trigger event; and
a second action;
receiving a context to read or change from a user, a foreign application, or the target application; and
after receiving the context, performing the first workflow comprising:
performing the first action on the target application or an operating system running the target application;
receiving a first indication that the first trigger event occurred; and
after receiving the first indication, performing the second action on the target application or the operating system,
wherein:
performing the first workflow drives the target application to a specific state where the context of the target application can be changed or the context of the target application can be read.

34. The method of claim 33, wherein:
receiving the first indication comprises:
receiving the first indication that the first trigger event occurred in the operating system or the target application.

35. The method of claim 33, wherein:
performing the second action occurs only after receiving the first indication.

36. The method of claim 33, wherein:
the first workflow further comprises:
a third action; and
a second trigger event;
performing the first workflow further comprises:
after performing the second action, receiving a second indication that the second trigger event occurred; and
after receiving the second indication, performing the third action on the target application or the operating system.

37. The method of claim 33, further comprising:
storing the first workflow.

38. The method of claim 33, further comprising:
retrieving the first workflow before the performing of the first workflow.

39. The method of claim 33, wherein:
providing the first workflow further comprises:
creating the first workflow.

40. The method of claim 33, further comprising:
if the first indication is not received, repeating the step of performing the first action.

41. The method of claim 33, further comprising:
if the first indication is not received, stopping the performance of the first workflow.
